(19) United States
(12) Patent Application Publication
(10) Pub. No.: US 2017/0161237 A1
(43) Pub. Date: Jun. 8, 2017

(54) METHOD FOR CREATING A HYPERLINK IN A VIDEO-PLAYING PAGE AND ELECTRONIC DEVICE

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Zhinan ZHANG, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/243,316

(22) Filed: Aug. 22, 2016

Related U.S. Application Data
(63) Continuation of application No. PCT/CN2016/089520, filed on Jul. 10, 2016.

(30) Foreign Application Priority Data
Dec. 3, 2015 (CN) 2015108821769X

(51) Int. Cl. G06F 17/22; G06F 17/27; G06F 17/30; G06F 17/24

(52) U.S. Cl. CPC G06F 17/2235; G06F 17/24; G06F 17/278; G06F 17/30882; G06F 17/30867; G06F 17/30855; G06F 3/0483

(57) ABSTRACT

Embodiments of the present disclosure relate to the field of communications technologies, and disclose a method and system for creating a hyperlink on a video-playing page and an electronic device. The method includes: acquiring an entry on a video-playing page; comparing the entry with a naming entity in a naming entity library, where the naming entity library includes a naming entity and a hyperlink address corresponding to the naming entity, and the hyperlink address is a search page associated with the naming entity; and when the entry matches the naming entity in the naming entity library, generating, on the video-playing page according to a hyperlink address of the naming entity matching the entry, a hyperlink corresponding to the entry.

### CROSS-REFERENCE TO RELATED APPLICATIONS

This application is a continuation of International Application No. PCT/CN2016/089520, with an international filing date of Jul. 10, 2016, which is based upon and claims priority to Chinese Patent Application No. 201510882176.9, filed on Dec. 3, 2015, the entire contents of all of which are incorporated herein by reference.

### TECHNICAL FIELD

Embodiments of the present disclosure relate to the field of communication technologies, and more particularly, to a method for creating a hyperlink on a video-playing page and an electronic device.

### BACKGROUND

A video-playing page (such as a video-playing page in a video APP) has multiple areas such as a video-playing area, a comment area, a relevant content area, and an advertisement area. Each area has a large amount of information content. The information content possibly includes information preferred by a user, such that the user hopes to link the information to relevant content to acquire the relevant content. Therefore, the content in each area plays an important role.

In the prior art, a user cannot click an entry on a video-playing webpage, for example, an entry that the user is interested in and that is in comments, to perform a further search to learn about the entry. For example, the video is relevant to a famous person, a name of the famous person exists in the comments, and the user wants to learn about the famous person. In this case, the user has to exit from the video-playing page, and perform a search to learn about the famous person on other pages (such as a search page). In this way, the user needs to spend time in switching pages and inputting an entry; therefore user experience is poor.

### SUMMARY

With respect to the technical problem in the prior art that a video-playing page does not have a link that enables the video-playing page to be switched to an entry that a user wants to learn about, an embodiment of the present invention provides a method for creating a hyperlink on a video-playing page, where the method includes:

acquiring an entry on a video-playing page;

comparing the entry with naming entities in a naming entity library, wherein the naming entity library comprises naming entities and hyperlink addresses corresponding to the naming entities, wherein the hyperlink addresses are search pages associated with the naming entities; and

when the entry matches a naming entity in the naming entity library, generating a hyperlink corresponding to the entry, in the video-playing page according to a hyperlink address of the naming entity matching the entry.

According to an embodiment of the present disclosure, there is provided with a non-transitory computer-readable storage medium storing executable instructions that, when executed by an electronic device, cause the electronic device to:

acquire an entry in a video-playing page;

compare the entry with naming entities in a naming entity library, wherein the naming entity library comprises naming entities and hyperlink addresses corresponding to the naming entities, wherein the hyperlink addresses are search pages associated with the naming entities; and

when the entry matches a naming entity in the naming entity library, generate a hyperlink corresponding to the entry, in the video-playing page according to a hyperlink address of the naming entity matching the entry.

According to an embodiment of the present disclosure, there is provided with an electronic device. The electronic device includes:

at least one processor and a memory communicably connected with the at least one processor for storing instructions executable by the at least one processor;

wherein execution of the instructions by the at least one processor causes the at least one processor to:

acquire an entry in a video-playing page;

compare the entry with naming entities in a naming entity library, wherein the naming entity library comprises naming entities and hyperlink addresses corresponding to the naming entities, wherein the hyperlink addresses are search pages associated with the naming entities; and

when the entry matches a naming entity in the naming entity library, generate a hyperlink corresponding to the entry, in the video-playing page according to a hyperlink address of the naming entity matching the entry.

Other characteristics and advantages of the embodiments of the present disclosure are described in detail in a subsequent part of specific implementation manners.

### BRIEF DESCRIPTION OF THE DRAWING FIGURES

The accompanying drawings are used to provide further understanding of the embodiments of the present disclosure, form a part of the specification, and are used to explain the present disclosure in combination with the following specific implementation manners, rather than form a limitation to the embodiments of the present disclosure. In the accompanying drawings:

FIG. 1 is a schematic structural diagram illustrating a system for creating a hyperlink on a video-playing page according to an embodiment of the present disclosure; and

FIG. 2 is an exemplary flowchart illustrating a method for creating a hyperlink on a video-playing page according to an embodiment of the present disclosure.

FIG. 3 is a schematic hardware diagram of an electronic apparatus for performing a method for creating a hyperlink on a video-playing page according to an embodiment of the present disclosure.

### DETAILED DESCRIPTION

Specific implementation manners of the present disclosure are described hereinafter in detail with reference to the accompanying drawings. It should be understood that the specific implementation manners described herein are merely used to describe and explain the present disclosure, but are not used to limit the present disclosure.

Hereinafter the concepts of the present disclosure are described by using examples, but it should be understood that the examples are non-limitative examples, and are not intended to limit the protection scope of embodiments of the present disclosure.

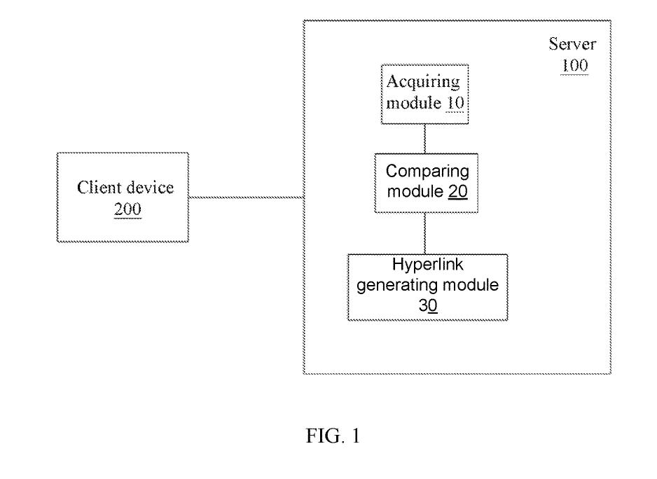

To describe the concepts of the present disclosure more clearly, detailed description is given by using a system for creating a hyperlink on a video-playing page as an example. FIG. 1 is a schematic structural diagram of a system for creating a hyperlink on a video-playing page according to an embodiment the present disclosure. As illustrated in FIG. 1, the system may include: a server 100 and a client device 200, which communicate with each other via a wired or wireless network. The client device 200 may be a device capable of communicating with the server, such as a mobile phone, a computer, and a tablet computer.

According to an implementation manner of the present disclosure, to create a hyperlink on a video-playing page, an embodiment of the present invention provides the server 100. The server 100 may include: an acquiring module 10, configured to acquire an entry on a video-playing page; a comparing module 20, configured to compare the entry with a naming entity in a naming entity library, where the naming entity library includes a naming entity and a hyperlink address corresponding to the naming entity, and the hyperlink address is a search page associated with the naming entity; and a hyperlink generating module 30, configured to: when the entry matches the naming entity in the naming entity library, generate, on the video-playing page according to a hyperlink address of the naming entity matching the entry, a hyperlink corresponding to the entry. In such an implementation manner, a hyperlink corresponding to an entry that a user is interested in can be generated on a video-playing page.

In an example, the server 100 may further include a pushing module, configured to push the video-playing page that includes the hyperlink corresponding to the entry to the client device 200. By mean of such an implementation manner, by clicking an entry that a user is interested in and that is on a video-playing page pushed forward to a client device, the user can conveniently and quickly switch the video-playing page to a search page associated with the entry, so as to learn about the entry, thereby saving time for the user and enhancing user experience.

Specifically, the server 100 may pre-configure a naming entity library. The naming entity library may include a naming entity and a hyperlink address corresponding to the naming entity, wherein the hyperlink address is a search page associated with the naming entity. Quantity of the naming entities may be any appropriate quantity. The naming entity may be any entity that uses a name as an identifier, such as a person name, a place name, and a film and television work name. Each naming entity corresponds to one hyperlink address, and the hyperlink address is the search page associated with the naming entity. For example, hyperlink addresses corresponding to a name of a famous person (such as Mr. A), a place name (such as Tiananmen), and/or a film and television work name (such as Iron Man) may be respectively relevant search pages (for example, a profile, a works introduction, and the like of Mr. A can be found on the search pages).

During a process of creating a hyperlink, first, the acquiring module 10 of the server 100 may acquire an entry on a video-playing page, such as acquiring the entry from a comment area on the video-playing page (being played on the client device or server), or may acquire the entry from any area that appropriately displays words such as a video introduction area. The acquiring module 10 may acquire the entry from the comment area on the video-playing page by using a segmenter (such as a Chinese segmenter, and a function and a working principle thereof are similar to those in the prior art, and are not further described herein). The entry is a noun or a noun phase acting as an identifier such as a person name, a place name, and a film and television work name. For example, “Mr. A” is extracted from words “Mr. A is good at acting” in the comment area as an entry, or “Golden Years” is extracted from words “Television Drama Golden Years” in the video page introduction area as an entry.

Subsequently, the comparing module 20 of the server 100 may compare the entry with a naming entity in the foregoing naming entity library. Then, when the entry matches the naming entity in the naming entity library, the hyperlink generating module 30 may generate, on the video-playing page according to a hyperlink address of the naming entity matching the entry, a hyperlink corresponding to the entry. For example, the comparing module 20 compares an entry “Mr. A” with each naming entity in the naming entity library. If a naming entity “Mr. A” matching the entry “Mr. A” is found, the hyperlink generating module 30 may generate, on the video-playing page according to a hyperlink address (for example, the hyperlink address may be a search page relevant to “Mr. A”, for example, a profile, a work introductions, and the like of Mr. A can be found on the search page) of the naming entity matching the entry, a hyperlink corresponding to the entry, that is, in this case, a hyperlink address corresponding to the entry “Mr. A” is to be generated in an address of the search page relevant to “Mr. A”. That is, the entry “Mr. A” in the words “Mr. A is good at acting” in the comment area on the video-playing page will have a hyperlink, that is “Mr. A is good at acting”, and the search page can be switched to by clicking the hyperlink. Alternatively, for example, the comparing module 20 compares an entry “Golden Years” with each naming entity in the naming entity library. If a naming entity “Golden Years” matching the entry “Golden Years” is found, the hyperlink generating module 30 can generate, on the video-playing page according to a hyperlink address (for example, the hyperlink address may be a search page relevant to “Golden Years”, for example, a brief introduction, a cast introduction, and the like of Golden Years can be found on the search page) of the naming entity matching the entry, a hyperlink corresponding to the entry. That is, in this case, a hyperlink address corresponding to the entry “Golden Years” is to be generated in an address of the search page relevant to “Golden Years”. That is, the entry “Golden Years” in the words “Television Drama Golden Years” in the video page introduction area of the video-playing page will have a hyperlink, that is, “Television Drama Golden Years”, and the search page can be switched to by clicking the hyperlink.

In an example, a pushing module of the server 100 can push the video-playing page that includes the hyperlink corresponding to the entry (for example, the foregoing exemplified “Mr. A is good at acting”) to a client device 200.

Correspondingly, when a user clicks the entry, the client device 200 can perform switching, via the hyperlink corresponding to the entry, from the video-playing page to the search page associated with the naming entity matching the entry. Specifically, on a side of the client device 200, when a user watches the video-playing page, the user can see words “Mr. A is good at acting” in the comment area or words “Television Drama Golden Years” in the video page introduction area. If the user is interested in the famous person Mr. A or Golden Years and wants to learn relevant information thereof, the user can click the entry (that is, clicking “Mr. A” in “Mr. A is good at acting”, or “Golden Years” in “Television Drama Golden Years”), and can perform switching, via the hyperlink corresponding to the entry, from the video-playing page to the search page associated with the naming entity matching the entry, such as switching video-playing page to a search page on which profile of “Mr. A” or brief introduction of “Golden Years” can be found without having to exit from the video-playing page and then searching for “Mr. A” or “Golden Years” on the search page.

In such an implementation manner, by clicking an entry that a user is interested and that is on a video-playing page and is pushed to a client device, the user can conveniently and quickly switch the video-playing page to a search page associated with the entry, so as to learn about the entry, thereby saving time for the user and enhancing user experience.

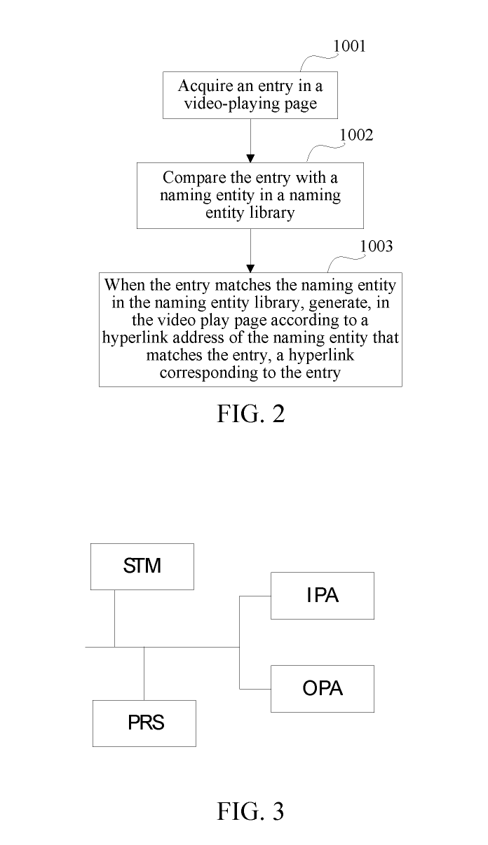

FIG. 2 is an exemplary flowchart of a method for creating a hyperlink on a video-playing page according to an implementation manner of the present disclosure. As illustrated in FIG. 2, the method may include the following steps:

In Step 1001, an entry on a video-playing page is required.

In Step 1002,the entry is compared with a naming entity in a naming entity library, wherein the naming entity library includes a naming entity and a hyperlink address corresponding to the naming entity, the hyperlink address being a search page associated with the naming entity.

In Step 1003, When the entry matches the naming entity in the naming entity library, a hyperlink corresponding to the entry is generated, on the video-playing page according to a hyperlink address of the naming entity matching the entry.

In an example, the method further includes: pushing the video-playing page that includes a hyperlink corresponding to the entry to a client device.

In an example, the method further includes: when a user clicks the entry at a client device, performing switching, via a hyperlink corresponding to the entry, from a video-playing page to a search page associated with a naming entity matching the entry.

In an example, the acquiring an entry on a video-playing page is specifically: acquiring the entry from a comment area on the video-playing page.

In an example, the acquiring the entry from a comment area on the video-playing page is specifically: acquiring the entry from the comment area on the video-playing page by using a segmenter.

It should be understood that each specific implementation manner in the foregoing method for creating a hyperlink on a video-playing page is exemplarily described in the implementation manners of the system for creating a hyperlink on a video-playing page (as described above), and is not described herein again. Moreover, a person skilled in the art can select any one of the foregoing implementation manners according to the invention of the present invention, or select a combination of the foregoing implementation manners to configure a client device and/or server, and other alternate implementation manners also fall within the protection scope of the present invention.

With the server and the method and system for creating a hyperlink on a video-playing page that are provided in the embodiments of the present invention, a user can directly enter a search result page by clicking an entry (which the user is interested in) on a video-playing page (such as comments), so as to conveniently and quickly learn information relevant to the entry, thereby saving time for the user and enhancing user experience.

According to an embodiment of the present disclosure, there is provided with a non-transitory computer-readable storage medium storing executable instructions that, when executed by an electronic apparatus, cause the electronic apparatus to perform any one of above disclosed methods.

FIG. 3 illustrates a schematic hardware diagram of an electronic device for performing any one of above disclosed methods. According to FIG. 3, the electronic device includes one or more processors PRS and a storage medium STM. FIG. 3 shows one processor PRS as an example.

The electronic device can further include an input apparatus IPA and an output apparatus OPA.

The one or more processors PRS, storage medium STM and output apparatus OPA may be connected by a bus or other means. FIG. 3 shows a bus as an example for connection.

Storage medium STM is a non-transitory computer-readable medium for storing a non-transitory software program, a non-transitory computer-readable program and module, for example the program instructions/module for performing an above described method (e.g. acquiring module 10, comparing module 20 and hyperlink generating module shown in FIG. 1). The processor PRS can operate the various functions and data processing of a server to perform a method described in the above embodiments by executing non-transitory software programs, instructions and modules stored in the storage medium STM.

The storage medium STM can include a program storage area and a data storage area. Among them, the program storage area may store operation system, application programs of at least one function; the data storage area may store generated data during operation of the electronic apparatus for performing the method described in the above embodiments. In addition, the storage medium STM may include a high speed random access memory, and a non-transitory storage medium, for example a magnetic storage device (e.g., hard disk, floppy disk, and magnetic strip), a flash memory device (e.g., card, stick, key drive) or other non-transitory solid state storage device. In some embodiments, the storage medium STM may include a storage medium that is remote to the processor PRS. The remote storage medium may be connected to the electronic device for performing any of the above methods by a network. The examples of such as network include but not limited to Internet, enterprise intranet, local area network, mobile telecommunication network and a combination thereof.

The input apparatus IPA can receive input number or byte information, and can generate input key information relating to user setting and functional control of the electronic apparatus for performing the method described in the above embodiments. The output apparatus OPA may include a display device such as a display screen.

The one or more modules stored in the storage medium STM that, when executed by the one or more processors PRS, can perform any of the above described methods.

The above products can execute any of the above described methods, and have correspondingly functional modules and effects. Details that are not disclosed in this embodiment can be understood by reference to the above method embodiments of the present disclosure.

An electronic device of the present disclosure can exist in various forms and includes but is not limited to:
(1) A mobile communication device which is capable of performing mobile communication function and having a main purpose for audio or data communication. Such a mobile communication device includes: a smart phone (e.g. iPhone), a multimedia phone, a functional mobile phone and a low-end mobile phone etc.
(2) A super-mobile personal computer which belongs to the field of a personal computer and has calculation and processing functions, and in general can access to a mobile network. Such a terminal device includes: a PDA, a MID and a UMPC etc., for example iPad.
(3) A portable entertainment device which is capable of displaying and playing multimedia content. Such a device includes: an audio player, a video-playinger(e.g. iPod), a handheld game console, an electronic book, a smart toy and a portable automotive navigation device.
(4) A server which can provide calculation service and can include a processor, a hard disk, a memory, a system bus etc. Such a server is similar to a general computer in terms of a computer structure, but is necessary to provide reliable service, which therefore requires a higher standard in certain aspects such as data processing, stability, reliability, security and compatibility and manageability etc.
(5) Other electronic apparatus that is capable of data exchange.

The above described apparatus embodiments are for illustration purpose only, in which modules/units that are described above as separated elements may be physically separate or not separate and modules/units that are described above as display elements may be or may not be a physical unit, i.e.in a same location or in various distributed network units. The skilled person in this field can understand that it is possible to select some or all of the units or modules to achieve the purpose of the embodiment.

According to the above description, the skilled person in this field can understand that various embodiments can be implemented by software over a general hardware platform or by hardware. Accordingly, the above technical solution or what is contributed to the prior art may be implemented in the form of software product. The computer software product may be stored in a computer-readable storage medium, for example random access memory (RAM), read only memory (ROM), compact disk (CD), digital versatile disk (DVD) etc. which includes instructions for generating a computing device (e.g. a personal computer, a server or a network device etc.) to perform a method of some or all parts of any one of the above described embodiments.

Although implementation manners of the present disclosure have been described in detail above with reference to the accompanying drawings, embodiments of the present invention are not limited to specific details in the foregoing implementation manners. Various simple variations may be made to the technical solutions of the present disclosure within the scope of the technical idea of the present disclosure , and such simple variations all fall within the protection scope of the present disclosure.

It should be further noted that the specific technical features described in the foregoing specific implementation manners can be combined in any appropriate manner as long as no conflict occurs. To avoid unnecessary repetition, various possible combination manners will not be described in the present disclosure.

In addition, various different implementation manners of the present disclosure may also be combined arbitrarily. Such combinations shall also be considered as the content disclosed by the present invention as long as these combinations do not depart from the concept of the present disclosure.

What is claimed is:

1. A method for creating a hyperlink in a video-playing page, comprising:
at a server;
acquiring an entry in a video-playing page;
comparing the entry with naming entities in a naming entity library, wherein the naming entity library comprises naming entities and hyperlink addresses corresponding to the naming entities, wherein the hyperlink addresses are search pages associated with the naming entities; and
when the entry matches a naming entity in the naming entity library, generating a hyperlink corresponding to the entry, in the video-playing page according to a hyperlink address of the naming entity matching the entry.

2. The method according to claim 1, further comprising: pushing the video-playing page comprising the hyperlink corresponding to the entry to a client device.

3. The method according to claim 1, further comprising: when a user clicks the entry on the client device, switching, via the hyperlink corresponding to the entry, from the video-playing page to a search page associated with the naming entity matching the entry.

4. The method according to claim 1, wherein the acquiring an entry on a video-playing page is specifically: acquiring the entry from a comment area on the video-playing page.

5. The method according to claim 2, wherein the acquiring an entry on a video-playing page is specifically: acquiring the entry from a comment area on the video-playing page.

6. The method according to claim 3, wherein the acquiring an entry on a video-playing page is specifically: acquiring the entry from a comment area on the video-playing page.

7. The method according to claim 4, wherein the acquiring the entry from a comment area on the video-playing page is specifically: acquiring the entry from the comment area in the video-playing page by using a segmenter.
video-playing

[symbol]

8. A non-transitory computer-readable storage medium storing executable instructions that, when executed by an electronic apparatus, cause the electronic apparatus to:
acquire an entry in a video-playing page;
compare the entry with naming entities in a naming entity library, wherein the naming entity library comprises naming entities and hyperlink addresses corresponding to the naming entities, wherein the hyperlink addresses are search pages associated with the naming entities; and
when the entry matches a naming entity in the naming entity library, generate a hyperlink corresponding to the entry, in the video-playing page according to a hyperlink address of the naming entity matching the entry.

9. The storage medium according to claim 8, wherein the storage medium further stores instructions to cause the electronic device to: push the video-playing page comprising the hyperlink corresponding to the entry to a client device.

10. The storage medium according to claim 8, wherein the storage medium further stores instructions to cause the electronic device to: switch, via the hyperlink corresponding to the entry, from the video-playing page to a search page associated with the naming entity matching the entry, when a user clicks the entry on the client device.

11. The storage medium according to claim 8, wherein the step to acquire an entry on a video-playing page the storage medium further comprises instructions to acquire the entry from a comment area on the video-playing page.

12. The method according to claim 9, wherein the step to acquire an entry on a video-playing page the storage medium further comprises instructions to acquire the entry from a comment area on the video-playing page.

13. The method according to claim 10, wherein the acquiring an entry on a video-playing page is specifically: acquiring the entry from a comment area on the video-playing page.

14. The storage medium according to claim 11, wherein the step to acquire the entry from a comment area on the video-playing page the storage medium further comprises instructions to acquire the entry from the comment area on the video-playing page by using a segmenter.

15. An electronic device, comprising:
at least one processor and a memory communicably connected with the at least one processor for storing instructions executable by the at least one processor;
wherein execution of the instructions by the at least one processor causes the at least one processor to:
acquire an entry in a video-playing page;
compare the entry with naming entities in a naming entity library, wherein the naming entity library comprises naming entities and hyperlink addresses corresponding to the naming entities, wherein the hyperlink addresses are search pages associated with the naming entities; and
when the entry matches a naming entity in the naming entity library, generate a hyperlink corresponding to the entry, in the video-playing page according to a hyperlink address of the naming entity matching the entry.

16. The electronic device according to claim 15, wherein the at least one processor is further caused to push the video-playing page comprising the hyperlink corresponding to the entry to a client device.

17. The electronic device according to claim 15, wherein the at least one processor is further caused to: switch, via the hyperlink corresponding to the entry, from the video-playing page to a search page associated with the naming entity matching the entry, when a user clicks the entry on the client device.

18. The electronic device according to claim 15, wherein the step to acquire an entry on a video-playing page the at least one processor is further caused to acquire the entry from a comment area on the video-playing page.

19. The electronic device according to claim 16, wherein the step to acquire an entry on a video-playing page the at least one processor is further caused to acquire the entry from a comment area on the video-playing page.

20. The electronic device according to claim 17, wherein the step to acquire an entry on a video-playing page the at least one processor is further caused to acquire the entry from a comment area on the video-playing page.

21. The electronic device according to claim 15, wherein the step to acquire the entry from a comment area on the video-playing page the at least one processor is further caused to acquire the entry from the comment area on the video-playing page by using a segmenter.
